(19) United States
(12) Patent Application Publication
(10) Pub. No.: US 2024/0174166 A1
(43) Pub. Date: May 30, 2024

(54) HEADLIGHT DEVICE FOR VEHICLE

(71) Applicant: HONDA MOTOR CO., LTD., Tokyo (JP)

(72) Inventors: Masayoshi TAKORI, Saitama (JP); Yuji TSUCHIYA, Saitama (JP); Shunsuke IWAO, Saitama (JP); Shinya KOGURE, Saitama (JP); Manabu SHIMIZU, Saitama (JP); Shuto OYAMA, Saitama (JP)

(21) Appl. No.: 18/551,610

(22) PCT Filed: Mar. 16, 2022
(86) PCT No.: PCT/JP2022/011792

§ 371 Date: Sep. 21, 2023

(30) Foreign Application Priority Data
Mar. 24, 2021 (JP) 2021-050146

(51) Int. Cl. B60Q 1/04; F21S 41/155; F21S 41/675

(52) U.S. Cl. CPC B60Q 1/04; F21S 41/155; F21S 41/675

(57) ABSTRACT

A headlight device for vehicle includes: a first light emission unit that illuminates a prescribed first light distribution area with light in a first illumination pattern in which bright areas and dark areas are alternately repeated; and a second light emission unit that illuminates a second light distribution area with light in a second illumination pattern in which the entire illuminated area is a bright area, wherein the first light distribution area has a portion that is beside the second light distribution area and does not overlap with the second light distribution area. In one aspect, the first illumination pattern is a grid pattern in which the bright areas in a grid shape are formed in the dark areas. In another aspect, the first illumination pattern is a stripe pattern in which the bright areas a1 and the dark areas are arranged in parallel.

### TECHNICAL FIELD

The present invention relates to a headlight device for a vehicle.

### BACKGROUND ART

As a headlight device for a vehicle, there has been proposed a device that allows the driver to visually recognize pedestrians easily while suppressing dazzling of the pedestrians (for example, see Patent Document 1). The headlight device for a vehicle of Patent Document 1 reduces the amount of illumination to the pedestrian's upper body according to the distance to the pedestrian acquired by the pedestrian detection sensor.
Patent Document 1: Japanese Unexamined Patent Application, Publication No. 2013-184614

### DISCLOSURE OF THE INVENTION

### Problems to be Solved by the Invention

However, there is a tendency for many accidents to occur due to overlooking of pedestrians in front of vehicles on a single straight road. It must be ensured that such overlooking of pedestrians does not occur, but the current headlight device for a vehicle is not sufficient in this regard, especially under adverse conditions such as nighttime and rainy weather.

In response to the above issue, it is an object of the present invention to provide a headlight device for a vehicle capable of improving overlooking of a pedestrian by a driver even under adverse conditions such as nighttime and rainy weather.

### Means for Solving the Problems

(1) A first aspect is a headlight device for a vehicle (e.g., the headlight device for a vehicle 1 described later) including a first light illuminator (e.g., the first light illuminator 3 described later) configured to illuminate a predetermined first light distribution area (e.g., the first light distribution area 19 described later) with light in a first illumination pattern (e.g., the first illumination pattern P1 described later) in which a bright area (e.g., the bright area a1 described later) and a dark area (e.g., the dark area a2 described later) are alternately repeated, and a second light illuminator (e.g., the second light illuminator 5 described later) configured to illuminate a predetermined second light distribution area (e.g., the second light distribution area 20 described later) with light in a second illumination pattern (e.g., the second illumination pattern P2 described later) in which an entire area is a bright area. The first light distribution area has a portion that does not overlap with the second light distribution area at a side of the second light distribution area.

(2) In a second aspect according to the first aspect, the first illumination pattern is a stripe pattern in which the bright area and the dark area are arranged in parallel.

(3) In a third aspect according to the first aspect, the first illumination pattern is a grid pattern in which the bright area having a grid pattern is formed in the dark area.

(4) In a fourth aspect according to the first aspect, the first illumination pattern is a checkerboard pattern in which the bright areas each having a rectangular shape and the dark areas each having a rectangular shape are arranged in a checkerboard pattern.

(5) In a fifth aspect according to the first aspect, the first illumination pattern is a rhombic checkerboard pattern in which the bright areas each having a rhombic shape and the dark areas each having a rhombic shape are arranged in a checkerboard pattern.

In a sixth aspect according to the first aspect, the first light illuminator includes a digital mirror device (DMD) including a micromirror group corresponding to the first illumination pattern.

(7) In a seventh aspect according to the first aspect, the first light illuminator includes a predetermined surface emitting light source and a light shielding mask having a pattern corresponding to the first illumination pattern.

(8) In an eighth aspect according to the first aspect, the second light distribution area is a spotlight distribution area narrower than a high beam.

(9) In a ninth aspect according to the eighth aspect, the second light distribution area has a cut-off line higher than a low beam.

### Effects of the Invention

(1) According to the headlight device for a vehicle of the first aspect, the presence of the pedestrian on the roadside is easily recognized by the driver due to human visual characteristics with the light emitted from the first light illuminator in the first illumination pattern in which the bright area and the dark area are alternately repeated. It is possible to improve overlooking of the pedestrian by the driver even under adverse conditions such as nighttime and rainy weather.

(2) According to the headlight device for a vehicle of the second aspect, when the pedestrian is illuminated with the light of the first illumination pattern, which is a stripe pattern in which the bright area and the dark area are arranged in parallel, the driver can easily recognize the presence of the pedestrian due to human visual characteristics.

(3) According to the headlight device for a vehicle of the third aspect, when the pedestrian is illuminated with the light of the first illumination pattern, which is a grid pattern in which the bright area having a grid pattern is formed in the dark area, the driver can easily recognize the presence of the pedestrian due to human visual characteristics.

(4) According to the headlight device for a vehicle of the fourth aspect, when the pedestrian is illuminated with the light of the first illumination pattern, which is a checkerboard pattern in which the bright areas each having a rectangular shape and the dark areas each having a rectangular shape are arranged in a checkerboard pattern, the driver can easily recognize the presence of the pedestrian due to human visual characteristics.

(5) According to the headlight device for a vehicle of the fifth aspect, when the pedestrian is illuminated with the light of the first illumination pattern, which is a rhombic checkerboard pattern in which the bright areas each having a rhombic shape and the dark areas each having a rhombic shape are arranged in a checkerboard pattern, the driver can easily recognize the presence of the pedestrian due to human visual characteristics.

(6) According to the headlight device for a vehicle of the sixth aspect, the presence of the pedestrian on the roadside is easily recognized by the driver due to human visual characteristics with the light emitted from a digital mirror device (DMD) including a micromirror group corresponding to the first illumination pattern, in the first illumination pattern, from the first light illuminator.

(7) According to the headlight device for a vehicle of the seventh aspect, the presence of the pedestrian on the roadside is easily recognized by the driver due to human visual characteristics with the light emitted from the first light illuminator including a predetermined surface emitting light source and a light shielding mask having a pattern corresponding to the first illumination pattern, in the first illumination pattern. It is possible to improve overlooking of the pedestrian by the driver even under adverse conditions such as nighttime and rainy weather.

(8) According to the headlight device for a vehicle of the eighth aspect, since the second light distribution area is a spotlight distribution area narrower than a high beam, the driver can reliably recognize the pedestrian without giving glare to the oncoming vehicle.

(9) According to the headlight device for a vehicle of the ninth aspect, since the second light distribution area has a cut-off line higher than a low beam, the driver can reliably recognize the pedestrian at a distant position.

### BRIEF DESCRIPTION OF THE DRAWINGS

FIG. 1 is a schematic diagram showing a headlight device for a vehicle according to an embodiment of the present invention;

FIG. 2 schematically shows human visual characteristics related to the technical idea of the present invention;

FIG. 3 is a diagram explaining the idea of light illumination by the headlight device for a vehicle according to the embodiment of the present invention;

FIG. 4 is a schematic diagram showing a nighttime driving field of view of a vehicle provided with the headlight devices for a vehicle according to the embodiment of the present invention;

FIG. 5 is a schematic diagram showing light distribution areas of the headlight device for a vehicle according to the embodiment of the present invention in plan view;

FIG. 6 shows a pedestrian on the side of a road illuminated with light of a first illumination pattern of the headlight device for a vehicle according to the embodiment of the present invention, from a driver's viewpoint;

FIG. 7 shows a pedestrian who is about to enter a roadway illuminated with light of the first illumination pattern of the headlight device for a vehicle according to the embodiment of the present invention, from a driver's viewpoint;

FIG. 8 shows a pedestrian entering a roadway illuminated with light of a second illumination pattern of the headlight device for a vehicle according to the embodiment of the present invention, from a driver's viewpoint;

FIG. 9 is a diagram explaining an influence of light of the first illumination pattern of the headlight device for a vehicle according to the embodiment of the present invention on a pedestrian;

FIG. 10 schematically shows a configuration of a first light illuminator of a headlight device for a vehicle according to an embodiment of the present invention;

FIG. 11 schematically shows a light shielding mask of the first light illuminator in the embodiment of FIG. 10 of the present invention;

FIG. 12 is a schematic diagram showing the illumination light of the first illumination pattern with the light shielding mask of FIG. 11 as seen in a nighttime driving field of view;

FIG. 13 schematically shows a configuration of a headlight device for a vehicle according to another embodiment of the present invention;

FIG. 14 schematically shows a light shielding mask in the embodiment of FIG. 13 of the present invention;

FIG. 15 is a schematic diagram showing the illumination light with the light shielding mask of FIG. 14 as seen in a nighttime driving field of view;

FIG. 16 schematically shows a modification of the first illumination pattern of the headlight device for a vehicle according to the embodiment of the present invention;

FIG. 17 schematically shows another modification of the first illumination pattern of the headlight device for a vehicle according to the embodiment of the present invention;

FIG. 18 schematically shows another modification of the first illumination pattern of the headlight device for a vehicle according to the embodiment of the present invention; and

FIG. 19 schematically shows another modification of the first illumination pattern of the headlight device for a vehicle according to the embodiment of the present invention.

### PREFERRED MODE FOR CARRYING OUT THE INVENTION

An embodiment of the present invention will now be described with reference to the drawings. In the following description, a light distribution area refers to a light illumination area, and an illumination pattern refers to the form of light illumination in the light distribution area.

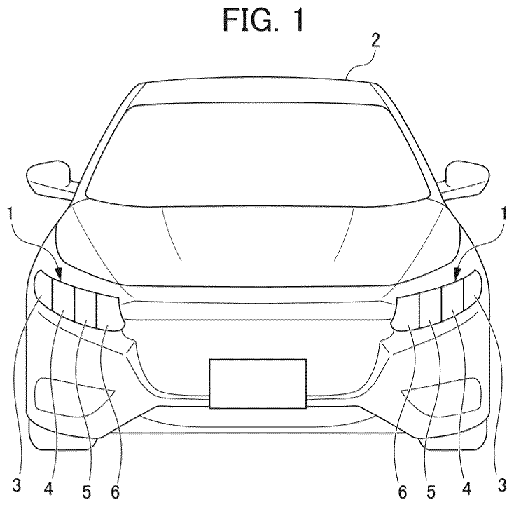

FIG. 1 is a schematic diagram showing headlight devices for a vehicle 1 according to the embodiment of the present invention. The headlight devices for a vehicle 1 are respectively provided on the left side and the right side of a vehicle 2, so as to be symmetrical when viewed from a center position in the vehicle width direction of the vehicle 2. In the headlight device for a vehicle 1, a first light illuminator 3, a low beam light illuminator 4, a second light illuminator 5, and a high beam light illuminator 6 are arranged in order from the outside toward the inside in the vehicle width direction.

The first light illuminator 3 illuminates a first light distribution area described later with light in a first illumination pattern in which a bright area and a dark area are alternately repeated. The low beam light illuminator 4 illuminates a predetermined low beam light distribution area with light. The second light illuminator 5 illuminates a second light distribution area described later with light in a second illumination pattern in which the entire area is a bright area. The high beam light illuminator 6 illuminates a predetermined high beam light distribution area with light. Here, although the case where the second light illuminator 5 is provided separately from the low beam light illuminator 4 and the high beam light illuminator 6 is shown, the present invention is not limited to this aspect. That is, the function of the second light illuminator 5 may be substantially covered by the low beam light illuminator 4 and/or the high beam light illuminator 6, and the second light illuminator 5 may not be provided separately. The vehicle 2 provided with the headlight devices for a vehicle 1 is hereinafter referred to as an own vehicle 2 as appropriate.

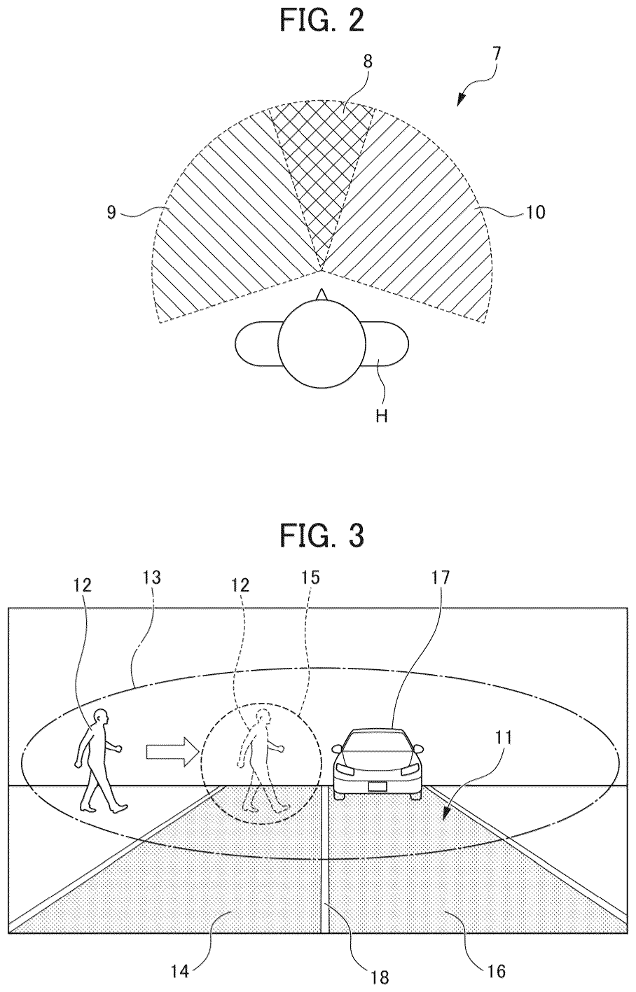

FIG. 2 schematically shows human visual characteristics related to the technical idea of the headlight device for a vehicle 1 of the present invention described later. In FIG. 2, a frontal field of view 7 of a human H is divided into a central field of view 8 spreading from the front to the left and right at a constant acute angle, and a left peripheral field of view 9 and a right peripheral field of view 10 that are adjacent to the left and right sides of the central field of view 8, based on human visual characteristics.

Based on general human visual characteristics, with regard to the central field of view 8, there is a tendency that shapes are clearly visible but the response to movement is slow. With regard to the left peripheral field of view 9 and the right peripheral field of view 10, there is a tendency that shapes are blurred but the response to movement is fast, i.e., the sensitivity to movement is high. The headlight device for a vehicle 1 of the present invention is based on the idea of positively utilizing the human visual characteristics as described above.

FIG. 3 is a diagram explaining the idea of light illumination by the headlight device for a vehicle 1 according to the embodiment of the present invention. Based on the fact that the driver of the vehicle has the above-described visual characteristics, the way of light illumination is devised as follows. That is, within a movement area 13 indicated by a dot-and-dash line that surrounds the movement path of a pedestrian 12 on one side of a road 11 crosses the road 11 to reach the other side of the road 11, an entrant area 15 indicated by a dashed line that surrounds the pedestrian 12 who has entered a traveling lane 14 of the own vehicle is set.

The movement area 13 is illuminated with light in the first illumination pattern, in which a bright area and a dark area are alternately repeated, such as in a stripe or grid pattern. The light is caused to act so as to effectively blink, whereby the movement of the pedestrian 12 can be quickly captured in the peripheral field of view (left peripheral field of view 9) that is highly sensitive to movement based on the visual characteristics of the driver. On the other hand, the entrant area 15 is illuminated with light in the second illumination pattern in which the entire area is a bright area, so that the appearance of the pedestrian 12 can be clearly captured in the central field of view 8 in which the shape can be clearly seen based on the visual characteristics of the driver.

In FIG. 3, an oncoming vehicle 17 is visually recognized on a traveling lane 16 opposite to the traveling lane 14 of the own vehicle. The oncoming vehicle 17 is located farther away than the pedestrian 12. The traveling lane 14 of the own vehicle and the traveling lane 16 on the opposite side are separated by a central separation line 18.

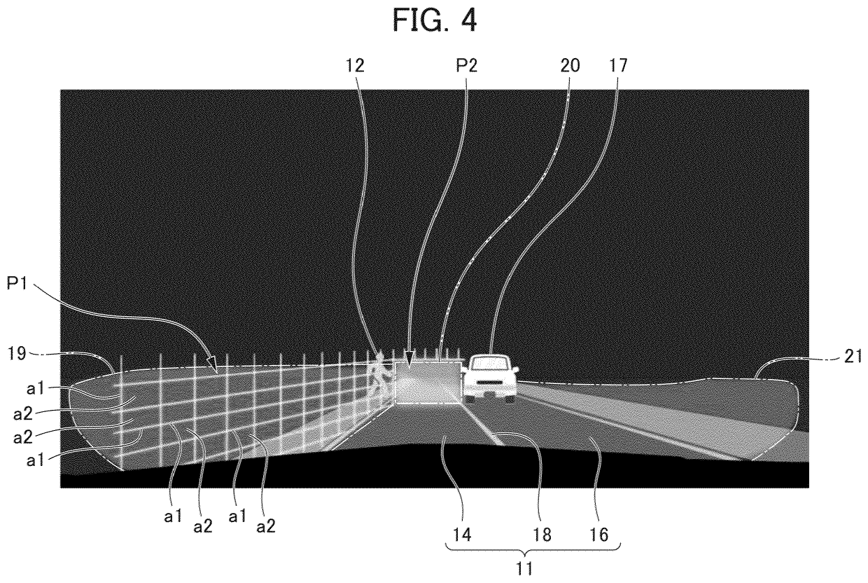

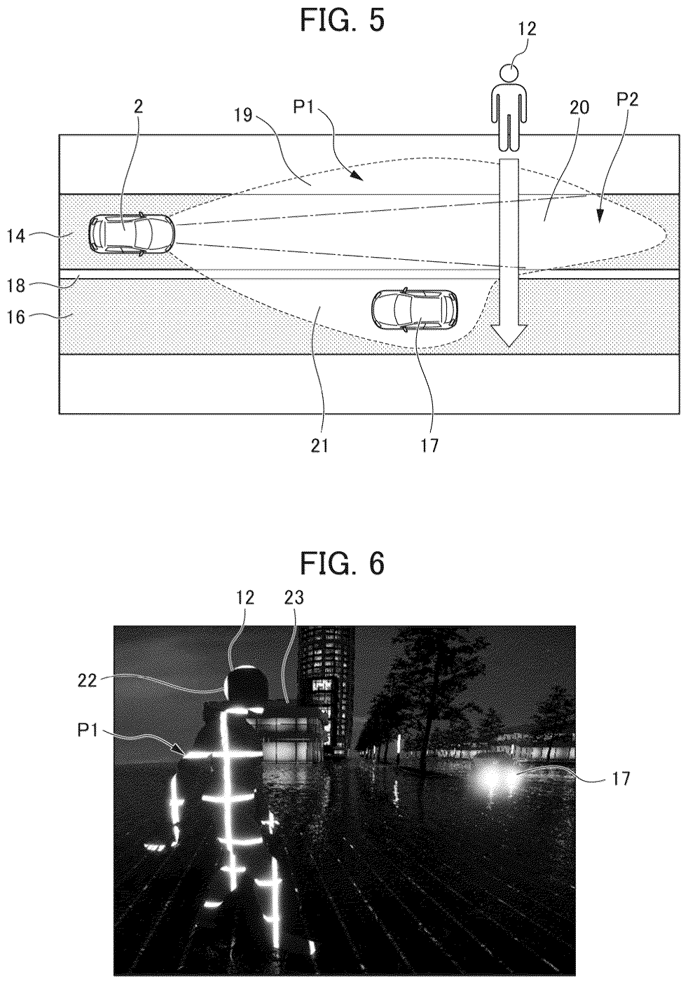

FIG. 4 is a schematic diagram showing a nighttime driving field of view of a vehicle (own vehicle 2) provided with the headlight devices for a vehicle 1 according to the embodiment of the present invention. FIG. 5 is a schematic diagram showing a light distribution area of the headlight device for a vehicle 1 in plan view. In FIGS. 4 and 5, the first light illuminator 3 (FIG. 1) of the headlight device for a vehicle 1 illuminates the first light distribution area 19, set so as to extend forward from the own vehicle along one side (left side) of the traveling lane 14 of the own vehicle, in a first illumination pattern P1 in which a bright area a1 and a dark area a2 are alternately repeated.

Furthermore, the second light illuminator 5 (FIG. 1) illuminates a second light distribution area 20 extending toward the front of the traveling lane 14 of the own vehicle in a second illumination pattern P2 in which the entire area is a bright area. The illumination light of the second illumination pattern P2 is spotlight whose directivity is focused forward. Furthermore, the low beam light illuminator 4 (FIG. 1) illuminates a low beam light distribution area 21 that extends across the traveling lane 14 of the own vehicle 2 and the traveling lane 16 on the opposite side. Since the oncoming vehicle 17 approaches, the high beam light illuminator 6 (FIG. 1) is turned off.

When the pedestrian 12 is in the first light distribution area 19, the pedestrian 12 is illuminated in the first illumination pattern P1 in which the bright area a1 and the dark area a2 are alternately repeated. The change of the reflected light with respect to the illumination light of the first illumination pattern P1 is extremely significant as compared with the change of the reflected light with respect to the illumination light of the illumination pattern in which the entire area is a bright area. Therefore, the driver easily notices the movement of the pedestrian 12, i.e., the presence of the pedestrian 12.

When the pedestrian 12 enters the forward part of the traveling lane 14 of the own vehicle, since the pedestrian 12 enters the second light distribution area 20 of the second light illuminator 5, the pedestrian 12 is illuminated with the light of the second illumination pattern P2 that is spotlight. A cut-off line of the second light distribution area is set higher than a low beam. Therefore, even if the pedestrian 12 is at a position where the pedestrian 12 is not illuminated with the illumination light from the low beam light illuminator 4, the appearance of the pedestrian 12 is clearly visually recognized with the illumination light from the second light illuminator 5. Furthermore, since the light in the second light distribution area is spotlight that does not spread to the traveling lane 16 on the opposite side, glare is prevented from being given to the ongoing vehicle 17.

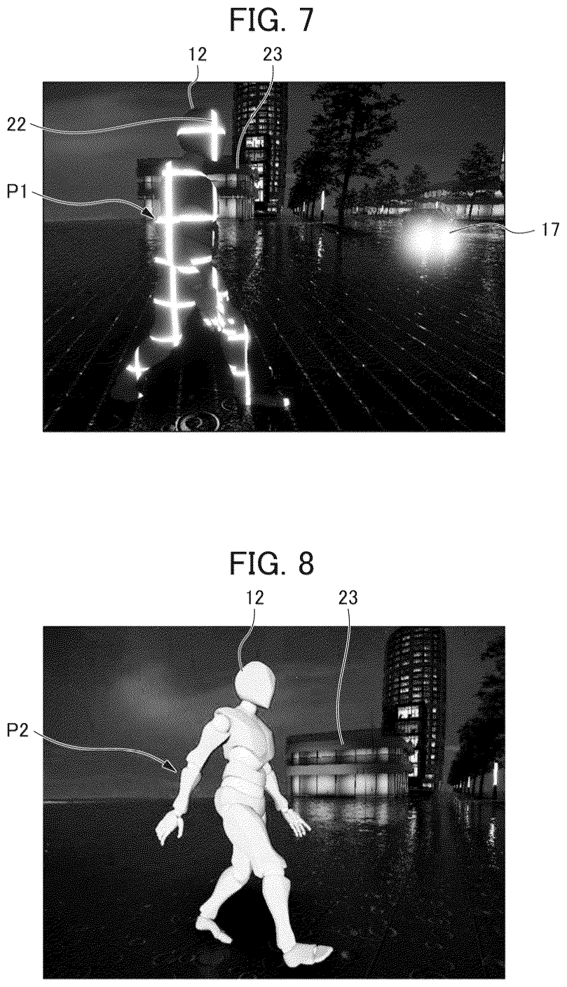

FIG. 6 shows the pedestrian 12 on the side of a road illuminated with the light of the first illumination pattern P1 by the first light illuminator 3 of the headlight device for a vehicle 1, from a driver's viewpoint. FIG. 7 shows the pedestrian 12 who is about to enter a roadway (traveling lane 14 of the own vehicle) illuminated with the light of the first illumination pattern P1 by the first light illuminator 3 of the headlight device for a vehicle 1, from a driver's viewpoint. FIG. 8 shows the pedestrian 12 entering the traveling lane 14 of the own vehicle illuminated with the light of the second illumination pattern P2 by the second light illuminator 5 of the headlight device for a vehicle 1, from a driver's viewpoint.

When the pedestrian 12 moves from the side of the road to enter the roadway (traveling lane 14 of the own vehicle), the shape of a bright portion 22 of a grid pattern illuminated with the light of the first illumination pattern P1 of the pedestrian 12 changes as understood in comparison with FIGS. 6 and 7. Since the bright portion 22 has a high contrast, the bright portion 22 can be clearly visually recognized even if a bright building 23 or the oncoming vehicle 17 on which a headlight is turned on is included in the field of view of the driver, or even if it is raining.

In practice, the shape of the bright portion 22 appears to be changing and moving due to human visual characteristics. Changes in the shape of the bright portion 22 occur in the peripheral field of view of the driver. Thereby, the driver can immediately recognize the presence of the pedestrian 12. The pedestrian 12 entering the traveling lane 14 of the own vehicle is illuminated with the light of the second illumination pattern P2 by the second light illuminator 5. Therefore, the driver can clearly visually recognize the appearance of the pedestrian 12.

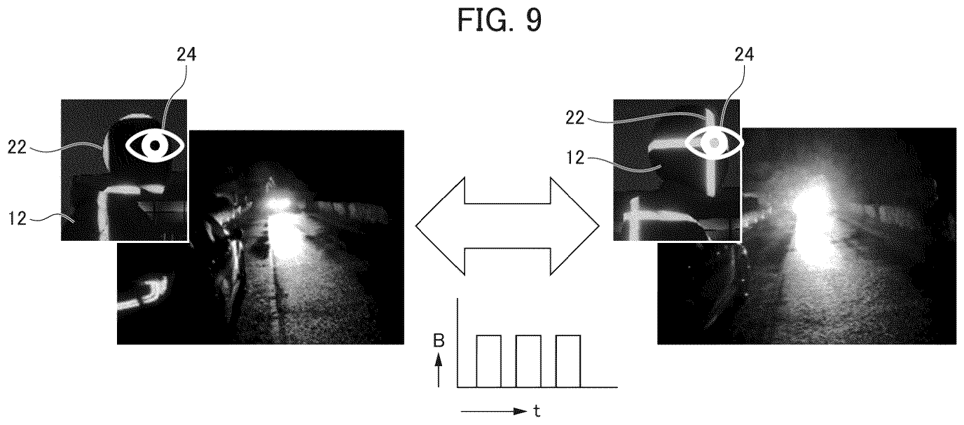

FIG. 9 is a diagram explaining an influence of the light of the first illumination pattern P1 of the headlight device for a vehicle 1 on the pedestrian 12. The left side of the double-headed arrow in the center of FIG. 9 shows the state of the field of view in which the pedestrian 12 perceives in a state in which the bright portion 22 of the light of the first illumination pattern P1 does not reach an eye 24 of the pedestrian 12. The right side of the double-headed arrow in the center of FIG. 9 shows the state of the field of view in which the pedestrian 12 perceives in a state in which the bright portion 22 of the light of the first illumination pattern P1 reaches the eye 24 of the pedestrian 12.

As the relative position of the pedestrian 12 and the light of the first illumination pattern P1 changes, the state on the left side of the double-headed arrow and the state on the right side alternate. Thus, the change over time of the blinking captured by the eye 24 of the pedestrian 12 exhibits a pulse shape as indicated below the double-headed arrow in the center of FIG. 9. Therefore, the pedestrian 12 can quickly recognize the presence of the vehicle.

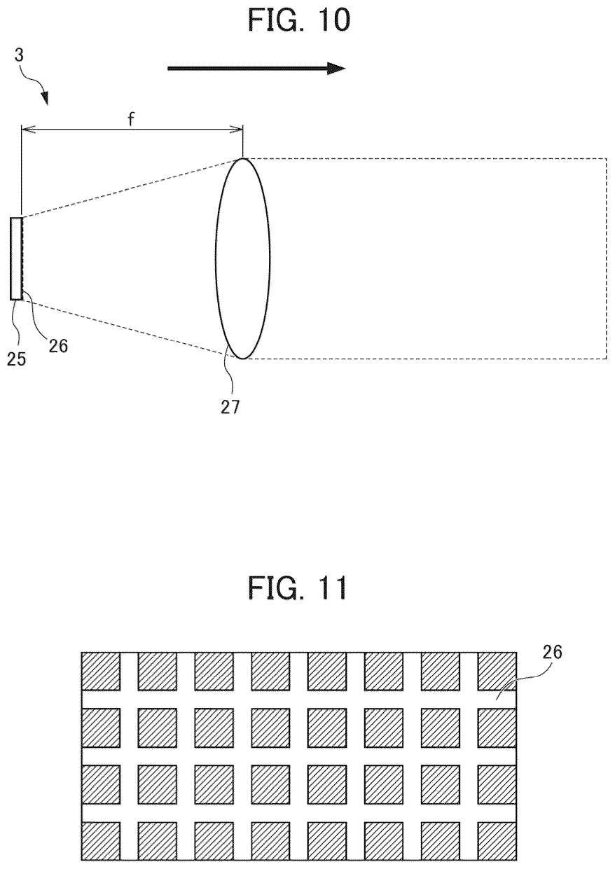

FIG. 10 schematically shows a configuration of the first light illuminator 3 of the headlight device for a vehicle. The first light illuminator 3 includes, for example, a surface emitting light source 25 in which a semiconductor light emitting element and an optical element are combined, a light shielding mask 26 disposed on a light emitting surface of the surface emitting light source 25, and a lens having a focal length f corresponding to the magnification of the illumination light. The light shielding mask 26 has a light shielding pattern corresponding to the first illumination pattern P1. In FIG. 10, the direction indicated by the arrow is the direction forward of the vehicle 2.

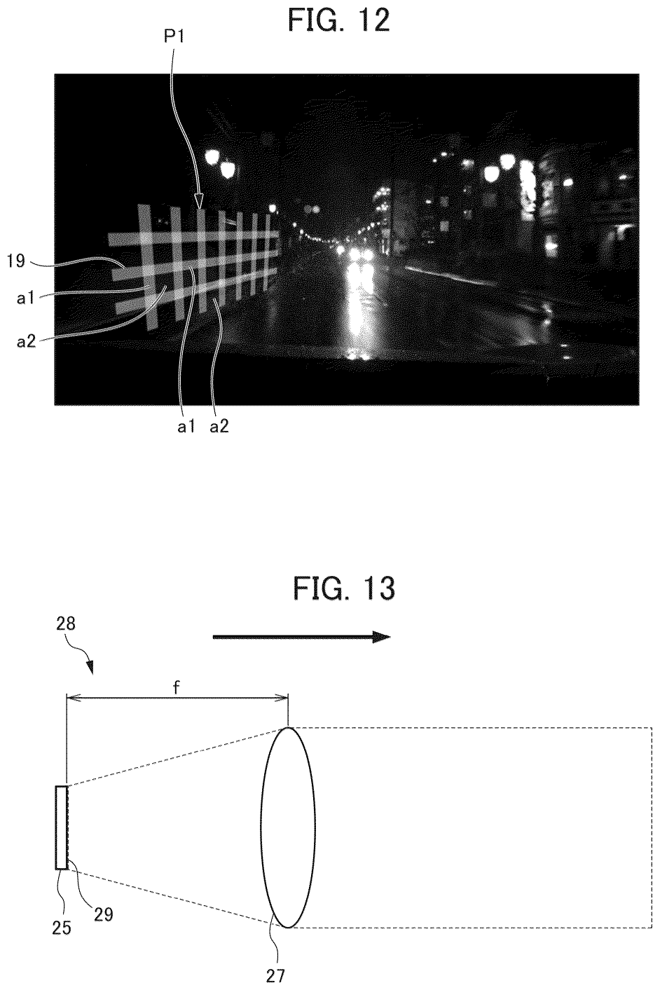

FIG. 11 schematically shows the light shielding mask 26 applied to the first light illuminator 3 in FIG. 10. FIG. 12 is a schematic diagram showing the illumination light of the first illumination pattern P1 with the light shielding mask 26 of FIG. 11 as seen in a nighttime driving field of view. A grid illumination light pattern, which is the first illumination pattern P1, with the light shielding mask 26, is illuminated to the first light distribution area 19 in front of the vehicle 2, and is visually recognized brightly in a grid pattern.

FIG. 13 schematically shows a configuration of a headlight device for a vehicle 1 according to another embodiment of the present invention. The difference between the embodiment of FIG. 13 and the embodiment of FIG. 10 is that in the embodiment of FIG. 13, the functions of the first light illuminator 3 and the second light illuminator 5 described above are integrated into a single pattern light illuminator 28. That is, the pattern light illuminator 28 illuminates the first light distribution area 19 with the illumination light of the first illumination pattern P1, and illuminates the second light distribution area 20 with the illumination light of the second illumination pattern P2.

The pattern light illuminator 28 includes the surface emitting light source 25, a light shielding mask 29 disposed on the light emitting surface of the surface emitting light source 25, and a lens having a focal length f corresponding to the magnification of the illumination light. As described later, the light shielding mask 29 has a light shielding pattern corresponding to the first illumination pattern P1 and the second illumination pattern P2. In FIG. 13, the direction indicated by the arrow is the direction forward of the vehicle 2.

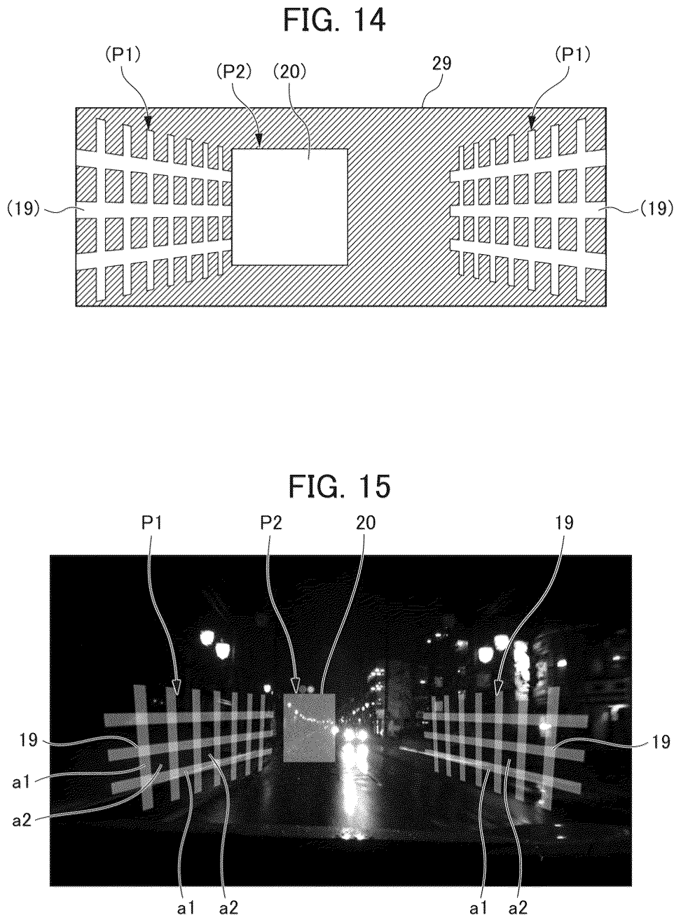

FIG. 14 schematically shows the light shielding mask 29 in the embodiment of FIG. 13. FIG. 15 is a schematic diagram showing the illumination light with the light shielding mask 29 of FIG. 14 as seen in a nighttime driving field of view. For convenience of explanation, portions in FIG. 14 corresponding to the illumination pattern in FIG. 15 are denoted by the same reference numerals in parentheses. The illumination pattern in FIG. 15 corresponds to a combination of the first illumination pattern P1 and the second illumination pattern P2 with the light shielding mask 29.

That is, it corresponds to a combination of a grid illumination pattern and a spot illumination pattern. With such a light shielding mask 29, the first light distribution area 19 in front of the vehicle 2 is illuminated with a grid illumination light pattern as the first illumination pattern P1, and the second light distribution area 20 is illuminated with a spot illumination pattern as the second illumination pattern P2. As a result, grid and spot light patterns are visibly recognized brightly.

The configuration of the first light illuminator 3 of the headlight device for a vehicle 1 according to the embodiment of the present invention is not limited to the embodiments shown in FIGS. 10 and 13. For example, the first light illuminator 3 may be configured by applying a digital mirror device (DMD) including a micromirror group that illuminates the first light distribution area 19 with light in the first illumination pattern P1. The presence of the pedestrian on the roadside is easily recognized by the driver due to human visual characteristics with the illumination light of the first illumination pattern P1 and in the first light distribution area 19 from the light illuminator 3 of the headlight device for a vehicle 1 including such a DMD. Even under adverse conditions such as nighttime and rainy weather, it is possible to improve overlooking of the pedestrian by the driver.

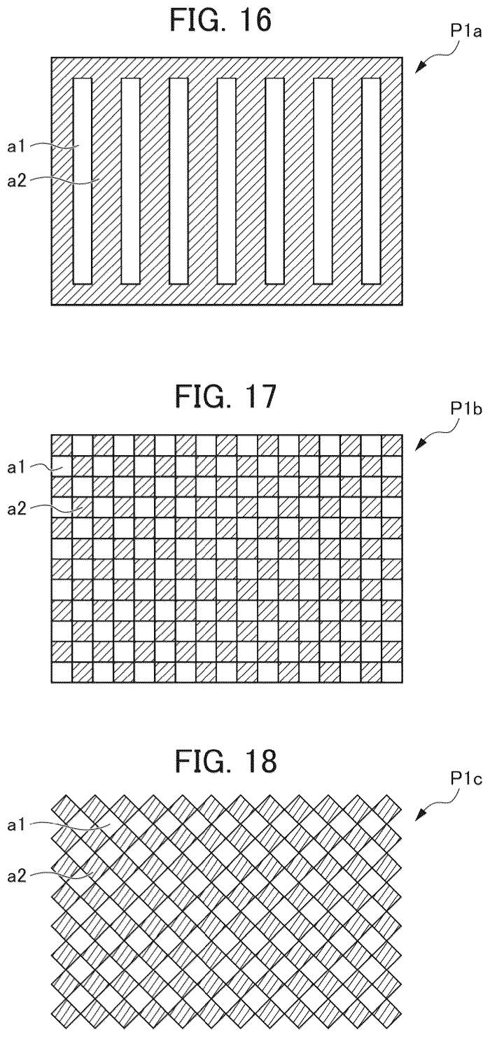

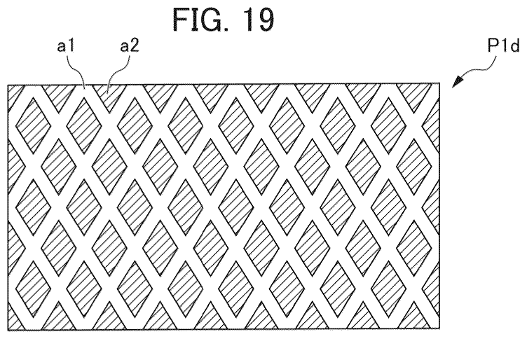

FIGS. 16 to 19 each schematically show a modification of the first illumination pattern of the headlight device for a vehicle 1. FIG. 16 shows a stripe pattern P1a in which bright areas a1 and dark areas a2 are arranged in parallel. The intervals between the bright areas a1 and the intervals between the dark areas a2 in the stripe pattern P1a do not necessarily need to be equal. FIG. 17 shows a checkerboard pattern P1b in which rectangular bright areas a1 and rectangular dark areas a2 are arranged in a checkerboard pattern. FIG. 18 shows a rhombic checkerboard pattern P1c in which rhombic bright areas a1 and rhombic dark areas a2 are arranged in a checkerboard pattern. FIG. 19 shows an oblique rhombic grid pattern P1d composed of a mesh pattern bright area a1 of an oblique rhombic grid and dark areas a2 surrounded by the bright area a1. The first illumination pattern of any of the aspects shown in FIGS. 16 to 19 allows the driver to easily recognize the presence of the pedestrian due to human visual characteristics.

According to the headlight device for a vehicle 1 of the present embodiment, the following effects can be achieved.

(1) The headlight device for a vehicle 1 according to a first aspect includes a first light illuminator 3 configured to illuminate a predetermined first light distribution area 19 with light in a first illumination pattern P1 in which a bright area a1 and a dark area a2 are alternately repeated, and a second light illuminator 5 configured to illuminate a predetermined second light distribution area 20 with light in a second illumination pattern P2 in which an entire area is a bright area. The first light distribution area 19 has a portion that does not overlap with the second light distribution area 20 at a side of the second light distribution area 20. Thus, the presence of the pedestrian 12 on the roadside is easily recognized by the driver due to human visual characteristics with the light emitted from the first light illuminator 3 in the first illumination pattern P1 in which the bright area a1 and the dark area a2 are alternately repeated. This can improve overlooking of the pedestrian 12 by the driver even under adverse conditions such as nighttime and rainy weather.

(2) In the headlight device for a vehicle 1 according to a second aspect, the first illumination pattern is a stripe pattern P1a in which the bright area a1 and the dark area a2 are arranged in parallel. When the pedestrian 12 is illuminated with the light of the first illumination pattern P1a, which is the stripe pattern P1a, the driver can easily recognize the presence of the pedestrian 12 due to human visual characteristics.

(3) In the headlight device for a vehicle 1 according to a third aspect, the first illumination pattern is a grid pattern P1 in which the bright area a1 having a grid pattern is formed in the dark area a2. When the pedestrian 12 is illuminated with the light of the first illumination pattern P1 which is the grid pattern P1, the driver can easily recognize the presence of the pedestrian 12 due to human visual characteristics.

(4) In the headlight device for a vehicle 1 according to a fourth aspect, the first illumination pattern is a checkerboard pattern P1b in which the bright areas a1 each having a rectangular shape and the dark areas a2 each having a rectangular shape are arranged in a checkerboard pattern. When the pedestrian 12 is illuminated with the light of the first illumination pattern which is the checkerboard pattern P1b, the driver can easily recognize the presence of the pedestrian 12 due to human visual characteristics.

(5) In the headlight device for a vehicle 1 according to a fifth aspect, the first illumination pattern is a rhombic checkerboard pattern P1c in which the bright areas a1 each having a rhombic shape and the dark areas a2 each having a rhombic shape are arranged in a checkerboard pattern. When the pedestrian 12 is illuminated with the light of the first illumination pattern which is the rhombic checkerboard pattern P1c, the driver can easily recognize the presence of the pedestrian 12 due to human visual characteristics.

(6) In the headlight device for a vehicle 1 according to a sixth aspect, the first light illuminator includes a digital mirror device (DMD) including a micromirror group corresponding to the first illumination pattern P1. The presence of the pedestrian 12 is easily recognized by the driver due to human visual characteristics with light emitted from the DMD including the micromirror group corresponding to the first illumination pattern P1, in the first illumination pattern P1, from the first light illuminator 3. It is possible to improve overlooking of the pedestrian 12 by the driver even under adverse conditions such as nighttime and rainy weather.

(7) In the headlight device for a vehicle 1 according to a seventh aspect, the first light illuminator 3 includes a surface emitting light source 25 and a light shielding mask 26 having a pattern corresponding to the first illumination pattern P1. The presence of the pedestrian 12 is easily recognized by the driver due to human visual characteristics with light emitted from the first light illuminator 3 in the first illumination pattern P1. It is possible to improve overlooking of the pedestrian 12 by the driver even under adverse conditions such as nighttime and rainy weather.

(8) In the headlight device for a vehicle 1 according to an eighth aspect, the second light distribution area 20 of the second light illuminator 5 is a spotlight distribution area narrower than a high beam. This allows the driver to reliably recognize the pedestrian 12 without giving glare to the oncoming vehicle.

(9) In the headlight device for a vehicle 1 of a ninth aspect according to the eighth aspect, the second light distribution area 20 has a cut-off line higher than a low beam. This allows the driver to reliably recognize the pedestrian 12 at a distant position.

Although the embodiments of the present invention have been described above, the present invention is not limited thereto. The features of the details may be changed as appropriate within the scope of the intent of the present invention. For example, a camera having an imaging field of view that is the illumination area of the illumination light by the headlight device for a vehicle 1 may be provided, and an information processing system may detect a pedestrian or other objects based on the output of the camera. The second light illuminator, which illuminates the predetermined second light distribution area with light in the second illumination pattern in which the entire area is a bright area, is, as an example, the second light illuminator 5 having the spotlight distribution area narrower than a high beam as described above, but the present invention is not limited to this aspect. That is, as described with reference to FIG. 1, the present invention is a technical idea that includes the case where the second light illuminator is a high beam light illuminator and/or a low beam light illuminator.

### EXPLANATION OF REFERENCE NUMERALS

a1 bright area
a2 dark area
H human
P1, P1a, P1b, P1c first illumination pattern
P2 second illumination pattern
1 headlight device for a vehicle
2 vehicle
3 first light illuminator
4 low beam light illuminator
5 second light illuminator
6 high beam light illuminator
7 frontal field of view
8 central field of view
9 left peripheral field of view
10 right peripheral field of view
11 road
12 pedestrian
13 movement area
14 traveling lane of own vehicle
15 entrant area
16 traveling lane on opposite side
17 oncoming vehicle
18 central separation line
19 first light distribution area
20 second light distribution area
21 low beam light distribution area
22 bright portion
23 building
24 eye
25 surface emitting light source
26 light shielding mask
27 lens
28 pattern light illuminator
29 light shielding mask

1. A headlight device for a vehicle, comprising:
a first light illuminator configured to illuminate a predetermined first light distribution area with light in a first illumination pattern in which a bright area and a dark area are alternately repeated; and
a second light illuminator configured to illuminate a predetermined second light distribution area with light in a second illumination pattern in which an entire area is a bright area,
wherein the first light distribution area has a portion that does not overlap with the second light distribution area at a side of the second light distribution area.

2. The headlight device for a vehicle according to claim 1, wherein the first illumination pattern is a stripe pattern in which the bright area and the dark area are arranged in parallel.

3. The headlight device for a vehicle according to claim 1, wherein the first illumination pattern is a grid pattern in which the bright area having a grid pattern is formed in the dark area.

4. The headlight device for a vehicle according to claim 1, wherein the first illumination pattern is a checkerboard pattern in which the bright areas each having a rectangular shape and the dark areas each having a rectangular shape are arranged in a checkerboard pattern.

5. The headlight device for a vehicle according to claim 1, wherein the first illumination pattern is a rhombic checkerboard pattern in which the bright areas each having a rhombic shape and the dark areas each having a rhombic shape are arranged in a checkerboard pattern.

6. The headlight device for a vehicle according to claim 1, wherein the first light illuminator comprises a digital mirror device (DMD) including a micromirror group corresponding to the first illumination pattern.

7. The headlight device for a vehicle according to claim 1, wherein the first light illuminator comprises a predetermined surface emitting light source and a light shielding mask having a pattern corresponding to the first illumination pattern.

8. The headlight device for a vehicle according to claim 1, wherein the second light distribution area is a spotlight distribution area narrower than a high beam.

9. The headlight device for a vehicle according to claim 8, wherein the second light distribution area has a cut-off line higher than a low beam.
